(19) United States
(12) Patent Application Publication
(10) Pub. No.: US 2017/0327613 A1
(43) Pub. Date: Nov. 16, 2017

(54) PROPYLENE BASED TERPOLYMER FOR CONTAINERS

(71) Applicant: BASELL POLIOLEFINE ITALIA S.R.L., Milano (IT)

(72) Inventors: Marco CIARAFONI, Ferrara (IT); Mara DESTRO, Ferrara (IT); Paola MASSARI, Ferrara (IT); Tiziana CAPUTO, Ferrara (IT); Thomas BÖHM, Darmstadt (DE)

(73) Assignee: Basell Poliolefine Italia S.r.l., Milano (IT)

(21) Appl. No.: 15/531,804

(22) PCT Filed: Nov. 17, 2015
(86) PCT No.: PCT/EP2015/076767

§ 371 Date: May 31, 2017

(30) Foreign Application Priority Data
Dec. 3, 2014 (EP) 14196159.9

(51) Int. Cl. C08F 210/06; B65D 1/02

(52) U.S. Cl. CPC C08F 210/06; B65D 1/02

(57) ABSTRACT

The present disclosure relates to a container comprising a propylene, ethylene, and 1-hexene terpolymer comprising:
(i) an ethylene content of 0.6-1.1 wt %;
(ii) a 1-hexene content of 1.1-2.8 wt %;
(iii) an ethylene to 1-hexene ratio (C₂/C₆) that fulfills the following equation (I);

C₂/C₆<0.39;
wherein C₂ is the ethylene content and C₆ is the 1-hexene content; and
(iv) the melt flow rate (MFR, ISO 1133, 230° C., 2.16 kg) is 32-64 g/10 min.

### FIELD OF THE INVENTION

The present disclosure relates to injection molded containers or thermoformed containers for food applications comprising a beneficial balance of mechanical and optical properties. In some embodiments, the containers comprise a propylene/ethylene/1-hexene terpolymer.

### BACKGROUND OF THE INVENTION

Propylene/ethylene/1-hexene terpolymers are used in commercial applications such as the production of pipes and films.

For example, WIPO Pat. App. Pub. No. WO 2006/002778 describes a pipe system comprising a terpolymer of propylene/ethylene and an alpha-olefin, where the ethylene content is 0-9% by mol and the 1-hexene content ranges from 0.2-5% wt.

U.S. Pat. No. 6,365,682 relates to propylene based terpolymers for films. The ethylene content ranges from 1-10 wt % and the alpha-olefin concentration ranges from 5 to 25 wt %, with terpolymers used in film preparation comprising an ethylene content of 0.9-3 wt % and an alpha-olefin content of 1 to 15 wt %

The applicant found that containers for food applications can be obtained by using a propylene-ethylene-1-hexene terpolymer having the compositions described herein.

### SUMMARY OF THE INVENTION

The present disclosure generally relates to a container for food applications comprising a propylene, ethylene, and 1-hexene terpolymer comprising:

i) an ethylene content of 0.6-1.1 wt %;

ii) a 1-hexene content of 1.1-2.8 wt %;

iii) a ratio of ethylene content wt % and 1-hexene content wt % (C₂/C₆) that fulfills the following equation (I):

0.20<C2/C6<0.39 (I);

wherein C₂ is the ethylene wt % and C₆ is the 1-hexene wt %; and

iv) a melt flow rate (MFR, ISO 1133, 230° C., 2.16 kg) of 30-64 g/10 min.

### DETAILED DESCRIPTION OF THE INVENTION

In some embodiments, the present disclosure relates to a container, such as a food container, comprising a propylene, ethylene, and 1-hexene terpolymer comprising:

i) an ethylene content of 0.6-1.1 wt %; such as from 0.6-0.9 wt %;

ii) a 1-hexene content of 1.1-2.8 wt %; including 1.3-2.6 wt % and 1.6-2.4 wt %;

iii) a ratio of ethylene content wt % and 1-hexene content wt % (C₂/C₆) that fulfills the following equation (I);

0.20<C₂/C₆<0.39 (I);

including embodiments where equation (I) is 0.20<C₂/C₆<0.38 and 0.20<C₂/C_{6<}0.37;

wherein C₂ is the ethylene wt % and C₆ is the 1-hexene wt %; and

iv) a melt flow rate (MFR, ISO 1133, 230° C., 2.16 kg) of 30-64 g/10 min; including 35-54 g/10 min and 41-44 g/10 min.

In some embodiments, the terpolymer comprises propylene, ethylene and 1-hexene, and the sum of these three comonomers is 100 wt %.

In certain embodiments, the area of the differential scanning calorimetry (DSC) curve after the peak of the melting point (Tₘ) represents less than 22% of the total area of the DSC curve.

In order to achieve the MFR of the terpolymer, in some embodiments it is possible to vis break a polymer having a lower MFR. In certain embodiments, vis breaking agents can be used such as peroxides may be used for adjusting the MFR of the terpolymer product.

In additional embodiments, the terpolymers of the present disclosure have an isotactic stereoregularity in their propylenic sequences by their low xylene extractables values, which may be lower than 15 wt %.

The containers disclosed herein are advantageously endowed with low levels of hexane extractables for food containing applications. The hexane extractables measured according to FDA 21 77:1520 with no powder is, in some embodiments, lower than 2.2 wt %; including lower than 2.1 wt % and equal to or lower than 2.0 wt %.

The injection molded container of the present disclosure is beneficially endowed with a low haze value. In certain embodiments, the haze value, as measured on a 0.4 mm wall of the container, is lower than 4.0%, such as than 3.5% and lower than 3.0%.

The containers of the present disclosure exhibit advantageously high impact values. For instance, in some embodiments a container having a 0.4 mm at 23° C. shows impact test values of greater than 2.0 J; including greater than 3.0 J and greater than 3.2 J. The disclosed containers further demonstrate good top load values. In additional embodiments, the top load of a container having a 0.4 mm thick wall thick is greater than 230 N; such as than greater than 250 N.

The injection molded container of the present disclosure is produced using known processes.

The terpolymer for use in the injection molded container of the present disclosure can be prepared by polymerization in one or more polymerization steps, optionally in the presence of Ziegler-Natta catalysts, which comprise a solid catalyst component comprising a titanium compound having at least one titanium-halogen bond and an electron-donor compound, both of which are supported on a magnesium halide support in active form. Ziegler-Natta catalysts may further comprise a co-catalyst component such as an organoaluminum compound, including aluminium alkyl compounds.

In some embodiments, an external electron donor is optionally added to the catalysts described herein.

In certain embodiments, the catalysts are capable of producing polypropylene with a xylene insolubility value at ambient temperature of greater than 90%, including greater than 95%.

Catalysts having the above mentioned characteristics are described, e.g. in U.S. Pat. Nos. 4,399,054 and 4,472,524, and EP Pat. No. 45977.

The solid catalyst components used in these catalysts may internal electron donors selected from the group consisting of ethers, ketones, lactones, compounds containing N, P and/or S atoms, and esters of mono- and dicarboxylic acids.

In certain embodiments, these internal electron-donor compounds are esters of phthalic acid and 1,3-diethers of the following general formulas:

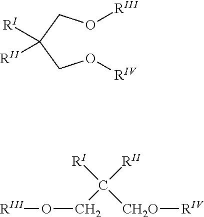

wherein R^{I} and R^{II} are the same or different and are selected from C₁-C₁₈ alkyl, C₃-C₁₈ cycloalkyl or C₇-C₁₈ aryl radicals; R^{III} and R^{IV} are the same or different and are selected from C₁-C₄ alkyl radicals; or are the 1,3-diethers in which the carbon atom in position 2 comprises a cyclic or polycyclic structure made up of 5, 6, or 7 carbon atoms, or of 5-n or 6-n′ carbon atoms, and the n nitrogen atoms and n∝ heteroatoms are selected from the group consisting of N, O, S and Si, where n is 1 or 2 and n′ is 1, 2, or 3, where the structure comprises two or three sites of unsaturation (cyclopolyenic structure) and is condensed with other cyclic structures, or substituted with one or more substituents selected from the group consisting of linear or branched alkyl radicals; cycloalkyl, aryl, aralkyl, alkaryl radicals and halogens, and condensed with other cyclic structures and substituted with one or more of the above mentioned substituents that may be bonded to the condensed cyclic structures; one or more of the above mentioned alkyl, cycloalkyl, aryl, aralkyl, or alkaryl radicals and the condensed cyclic structures, optionally containing one or more heteroatom(s) as substitutes for carbon or hydrogen atoms, or both.

Ethers of this type are described in EP Pat. Apps. 361493 and 728769.

In some embodiments, diethers for use as internal electron donor compounds are selected from 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane and 9,9-bis (methoxymethyl) fluorene.

Additional electron-donor compounds for use in the present disclosure are phthalic acid esters such as diisobutyl, dioctyl, diphenyl and benzylbutyl phthalate.

In additional embodiments, mixtures of at least two electron donor compounds, one of which comprises succinate(s) at 30-90% by mol with respect to the total amount of donors and the second of which is selected from 1,3 diethers, may be used.

The preparation of the catalyst component described herein may be performed in accordance with knowledge known in the relevant art.

For example, a MgCl₂.nROH adduct (e.g., in the form of spheroidal particles) wherein n is from 1-3 and ROH is selected from ethanol, butanol and isobutanol, is reacted with an excess of TiCl₄ comprising an electron donor compound at a temperature of about 80-120° C. The solid is then isolated and reacted once more with TiCl₄ in the presence or absence of the electron-donor compound, after which it is separated and washed with aliquots of a hydrocarbon to remove any chloride ions.

In some embodiments, the titanium compound, expressed as Ti, in the solid catalyst component may be present in an amount from 0.5-10% by weight. The quantity of electron-donor compound which remains fixed on the solid catalyst component may be from about 5-20% by mole with respect to the magnesium dihalide concentration.

The titanium compounds, which can be used for the preparation of the solid catalyst component, may be selected from halides and halogen alcoholates of titanium, including but not limited to titanium tetrachloride.

These reactions produce a magnesium halide in active form. Other reactions known in the literature, which cause the formation of magnesium halide in active form starting from magnesium compounds other than halides, such as magnesium carboxylates, may also be used.

The Al-alkyl compounds used as co-catalysts in the present disclosure may comprise Al-trialkyls, such as Al-triethyl, Al-triisobutyl, Al-tri-n-butyl, and linear or cyclic Al-alkyl compounds containing two or more Al atoms, bonded to each other via O, N, SO₄ or SO₃.

In some embodiments, the Al-alkyl compound may be used in such a quantity that the Al/Ti ratio is 1-1000.

The electron donor compounds that can be used as external donors include aromatic acid esters such as alkyl benzoates and silicon compounds containing at least one Si—OR bond, where R is a hydrocarbon radical.

Examples of these silicon compounds are (tert-butyl)₂Si(OCH₃)₂, (cyclohexyl)(methyl)Si(OCH₃)₂, (cyclopentyl)₂Si(OCH₃)₂ and (phenyl)₂Si(OCH₃)₂ and (1,1,2-trimethylpropyl)Si(OCH₃)₃.

1,3-diethers having the formulas described above can also be used. If the internal electron donor is one of these diethers, the external electron donor(s) can be omitted.

In some embodiments, the terpolymers may be prepared using catalysts comprising a phthalate as an internal electron donor and (cyclopentyl)₂Si(OCH₃)₂ as an external electron donor, or 1,3-diethers may be used as internal electron donors.

The propylene-ethylene-hexene-1 polymers may be produced, in some embodiments, with the polymerization process illustrated in EP Pat. App. 1 012 195.

As described therein, the process comprises feeding the monomers to the polymerization zones in the presence of catalyst under reaction conditions and collecting the polymer product from the polymerization zones. The growing polymer particles flow upward through one (the first) of the polymerization zones (referred to as the riser) under fast fluidization conditions, leave the riser and enter another (the second) polymerization zone (referred to as the downcomer), through which they flow downward in a densified form under the action of gravity, leave the downcomer and are reintroduced into the riser, thus establishing a circulation of polymer between the riser and the downcomer.

In the downcomer, high density values for the solid are reached, which approach the bulk density of the polymer. A positive gain in pressure can be obtained along the direction of flow so that it becomes possible to reintroduce the polymer into the riser without additional mechanical means. In this way, a “loop” circulation is set up, which is defined by the balance of pressures between the two polymerization zones and by the head loss introduced into the system.

Generally, the condition of fast fluidization in the riser is established by feeding a gas mixture comprising the monomers to the riser. In some embodiments, the feeding of the gas mixture is effected below the point of reintroduction of the polymer into the riser by the optional use of a gas distributor. The velocity of the transport gas into the riser may be higher than the transport velocity under the operating conditions, such as from 2-15 m/s.

In some embodiments, the polymer and the gaseous mixture leaving the riser are conveyed to a solid/gas separation zone. The solid/gas separation can be manipulated using conventional separation means. From the separation zone, the polymer enters the downcomer. The gaseous mixture leaving the separation zone is compressed, cooled and transferred, optionally with the addition of make-up monomers and/or molecular weight regulators, to the riser. The transfer can be further manipulated via a recycle line for the gaseous mixture.

The control of the polymer circulating between the two polymerization zones can be adjusted by metering the amount of polymer leaving the downcomer using means for controlling the flow of solids, such as mechanical valves.

The operating temperatures are, in some embodiments, from 50-120° C.

The first stage process can be carried out under operating pressures of 0.5-10 MPa, including 1.5-6 MPa.

Advantageously, one or more inert gases may be maintained in the polymerization zone(s) in such quantities that the sum of the partial pressure of the inert gases may be 5-80% of the total pressure of the gases. In certain embodiments, the inert gas is selected from nitrogen and propane.

The various catalysts for use in the present disclosure may be fed up to the riser at any point in the riser and the downcomer. The catalysts can be in any physical state, therefore catalysts in either the solid or liquid state can be used.

In some embodiments, conventional additives, fillers and pigments, may be added to the terpolymer, such as nucleating agents, extension oils, mineral fillers, and other organic and inorganic pigments. The addition of inorganic fillers, such as talc, calcium carbonate and mineral fillers, may improve the mechanical properties of the disclosed composition, such as flexural modulus and HDT. Talc can also have a nucleating effect.

In certain embodiments, one or more nucleating agents are added to the compositions of the present disclosure in quantities ranging from 0.05-2% by weight, including 0.1-1% by weight, with respect to the total weight of the terpolymer.

In further embodiments, the containers of the present disclosure can have various shapes, such as cubic, conic, circular a irregular shapes.

### EXAMPLES

The following examples are included to demonstrate certain embodiments of the present disclosure. It should be appreciated by those of skill in the art that the techniques disclosed in the examples which follow represent techniques discovered by the inventors to function well in the practice of the disclosed technology. However, those of skill in the art should, in light of the present disclosure, appreciate that many changes can be made in the specific embodiments which are disclosed and still obtain a like or similar result without departing from the spirit and scope of the disclosed technology.

### Example 1

### Characterization Methods

Melting Temperature and Crystallization Temperature:

Determined by differential scanning calorimetry (DSC) by weighing out 6±1 mg of the composition, which is heated to 220±1° C. at a rate of 20° C./min and kept at 220±1° C. for 2 minutes in a nitrogen stream and thereafter cooled at a rate of 20° C./min to 40±2° C., and kept at this temperature for 2 min to crystallize the sample. Then, the sample is again fused at an increasing temperature rate of 20° C./min up to 220° C.±1° C. The melting scan is recorded, a thermogram is obtained, and, from this, melting temperatures and crystallization temperatures are determined.

Melt Flow Rate (MFR)

Determined according to ISO 1133 (230° C., 5 kg).

Solubility in xylene (XS):

2.5 g of polymer and 250 ml of xylene are introduced in a glass flask equipped with a refrigerator and a magnetic stirrer. The temperature is increased over 30 minutes up to the boiling point of the solvent. The resulting clear solution is then kept under reflux and stirred for 30 minutes. The closed flask is then kept for 30 minutes in a bath of ice/water, and further in a thermostatic water bath at 25° C. for 30 minutes. The resulting solid is filtered on quick filtering paper. 100 ml of the filtered liquid is poured in a previously weighed aluminium container, which is heated on a heating plate under nitrogen flow to evaporate the solvent. The container is kept on an oven at 80° C. under vacuum until a constant weight is obtained. The weight percentage of polymer soluble in xylene at room temperature is then calculated.

1-hexene and ethylene Content:

Determined by ¹³C NMR spectroscopy of the terpolymer.

NMR analysis. ¹³C NMR spectra are acquired on an AV-600 spectrometer operating at 150.91 MHz in Fourier transform (FT) mode at 120° C. The peak of the propylene CH moiety was used as an internal reference at 28.83 ppm. The 13C NMR spectrum is acquired using the following parameters:
Spectral width (SW): 60 ppm
Spectrum center (O1): 30 ppm
Decoupling sequence: WALTZ 65_64 pl
Pulse program⁽¹⁾: ZGPG
Pulse Length (P1)⁽²⁾: 90°
Total number of data points (TD): 32 K
Relaxation Delay⁽²⁾: 15 s
Number of transients⁽³⁾: 1500

The total amount of 1-hexene and ethylene as a molar percentage is calculated from the diad using the following equations:

[P]=PP+0.5PH+0.5PE

[H]=HH+0.5PH

[E]=EE+0.5PE

Assignments of the ¹³C NMR spectrum of propylene/1-hexene/ethylene copolymers were calculated according to the following table:

| Area | Chemical Shift | Assignments | Sequence |
|---|---|---|---|
| 1 | 46.93 − 46.00 | S | PP |
| 2 | 44.50 − 43.82 | S | PH |
| 3 | 41.34 − 4.23 | S | HH |
| 4 | 38.00 − 37.40 | S + S | PE |
| 5 | 35.70 − 35.0 | 4B₄ | H |
| 6 | 35.00 − 34.53 | S + S | HE |
| 7 | 33.75 33.20 | CH | H |
| 8 | 33.24 | T | EPE |
| 9 | 30.92 | T | PPE |
| 10 | 30.76 | S | XEEX |
| 11 | 30.35 | S | XEEE |
| 12 | 29.95 | S | EEE |
| 13 | 29.35 | 3B₄ | H |
| 14 | 28.94 − 28.38 | CH | P |
| 15 | 27.43 − 27.27 | S | XEE |
| 16 | 24.67 − 24.53 | S | XEX |
| 17 | 23.44 − 23.35 | 2B₄ | H |
| 18 | 21.80 − 19.90 | CH₃ | P |
| 19 | 14.22 | CH₃ | H |

Haze (on a 1 mm Plaque):

5×5 cm specimens were cut from molded plaques of 1 mm thickness, and the haze value was measured using a Gardner photometer equipped with a UX-10 haze meter (GE 1209 lamp, filter C). The instrument was calibrated by carrying out a measurement in the absence of the sample (0% haze) and a measurement with an intercepted light beam (100% haze).

The measurement and computation principles are provided in ASTM-D1003.

The plaques were produced according to the following method: 75×75×2 mm plaques were molded with a GBF Plastinjector G235/90 injection molding machine at 90 tons under the following processing conditions:

Screw rotation speed: 120 rpm

Back pressure: 10 bar

Melt temperature: 260° C.

Injection time: 5 sec

Switch to hold pressure: 50 bar

First stage hold pressure: 30 bar

Second stage pressure: 20 bar

Hold pressure profile: First stage: 5 sec
Second stage: 10 sec

Cooling time: 20 sec

Mold water temperature: 40° C.

The plaques were conditioned for 12-48 hours at a relative humidity of 50% and a temperature of 23° C.

Haze on the Container:

The haze on the container was measured by cutting 5×5 cm specimens from the container wall and using the above described procedure for haze determination (on 2 mm plaques).

Top Load:

After at least 70 hours of conditioning at 23° C. and 50% relative humidity, the container is placed between the two plates of the dynamometer and compressed with a stress velocity relative to the plate of 10 mm/min.

The stress at collapse of the container is recorded, and the value reported in Newtons (N). The top load value is the mean value obtained from measurements repeated on six injection molded containers.

Container Impact Test (CIT):

The test is a biaxial impact test, the container, bottom up, was put on a sample older, having the same dimension of the container

The plate for the impact has a diameter of 62 mm and 5 kg of weight, it falls from 600 mm. The results are expressed in Joule. The results are an average of 10 tests.

Containers to be tested are produced with an injection moulding machine with the following specs:

Injection Moulding Unit Parameters:

Injection screw stroke: 1200 kN

Screw diameter: 32 mm

Injected volume: 102.9 cm3

Screw ratio L/D: 20

Max injection press: 2151 bar

The items to be tested had the following characteristics:

Volume: 250 cc

Surface treatment: Polished

The shape of the container was a truncated pyramid with a square base, where the top base had a side of 70 mm, the bottom base had a side of 50 mm, and the height was 80 mm.

IZOD Impact Strength:

Determined according to IS0 180/1A. Samples were obtained according to ISO 294-2.

Hexane Extractables:

Measured according to FDA 21 77:1520.

### Example 1 and Comparative Example 2

Terpolymers are prepared by polymerizing propylene, ethylene and hexene-1 in the presence of a catalyst under continuous conditions in a plant comprising a polymerization apparatus as described in EP Pat. No. 1 012 195.

The catalyst is sent to a polymerization apparatus comprising two interconnected cylindrical reactors, a riser and a downcomer. Fast fluidization conditions are established in the riser by recycling gas from the gas-solid separator. In Examples 1-2, no barrier feed was used.

The catalyst employed comprises a catalyst component prepared per Example 5 of EP Pat. App. 728769, but using microspheroidal MgCl₂.1.7C₂HsOH instead of MgCl₂.2.1C₂H₅OH. This catalyst component is used with dicyclopentyl dimethoxysilane (DCPMS) as an external electron donor, with triethylaluminum (TEAL) used as a co-catalyst.

The polymer particles exiting the reactor were subjected to steam treatment to remove any reactive monomers and volatile substances, followed by drying of the particles. The main operative conditions and characteristics of the resulting polymers are disclosed in Table 1.

TABLE 1
Polymerization Process

| Example | | Ex. 1 | Comp. Ex. 2 |
|---|---|---|---|
| TEAL/external donor | wt/wt | 4 | 4 |
| TEAL/catalyst | wt/wt | 6 | 6 |
| Temperature | ° C. | 80 | 80 |
| Pressure | bar-g | 25 | 23 |
| Split holdup riser | wt % | 42 | 42 |
| downcomer | wt % | 58 | 58 |
| C₆⁻ riser | mole % | 1.27 | 1.5 |
| C₂⁻ riser | mole % | 0.78 | 0.92 |
| H₂/C₃⁻ riser | mol/mol | 0.08 | 0.072 |
| C₆⁻/(C₆⁻ + C₃⁻) | mol/mol | 0.016 | 0.023 |

C₂⁻ = ethylene
C₃⁻ = propylene
C₆⁻ = 1-hexene

The polymer particles of examples 1-4 are introduced in an extruder, wherein they are mixed with 500 ppm of Irganox® 1010, 1000 ppm of Irgafos® 168, 500 ppm of calcium stearate, 1000 ppm of GMS-90® and 0.4% of NX 800 (1800 ppm of Millad® 3988 for Comparative Example 2). The polymer particles were extruded under nitrogen atmosphere in a twin screw extruder at a rotation speed of 250 rpm and a melt temperature of about 200-250° C.

The properties of the resulting material are reported in Table 2.

TABLE 2

| | | Ex. 1 | Comp Ex 2 |
|---|---|---|---|
| Ethylene content | Wt % | 0.8 | 1.0 |
| 1-hexene content | Wt % | 2.2 | 3.0 |
| Xylene solubles | Wt % | 3.4 | 4.2 |
| Hexane extractables (film) | % | 1.9 | 1.6 |
| MFR | dl/g | 44 | 24.9 |
| Izod Impact (23° C.) | kJ/m2 | 3.6 | 3.5 |
| Melting point | ° C. | 146.3 | 142.3 |
| C₂/C₆ | | 0.36 | 0.33 |
| Flexural modulus | MPa | 1240 | 1150 |
| Haze (1 mm plaque) | % | 5.1 | 6.5 |

The resulting polymer was injection molded into containers as described above. The injection molded containers were analyzed, and the results are reported in Table 3.

TABLE 3

| | | Ex. 1 | Comp Ex 2 |
|---|---|---|---|
| Top Load | N | 275 | 225 |
| Haze on 0.4 mm | % | 2.9 | — |
| thick container | | | |

The results disclosed in Table 3 demonstrate the improved top load and haze values of the disclosed technology. These unexpected properties are not predictable from the raw material. For instance, as shown in Table 2 the flexural modulus of the two polymers is about the same (the difference is about 7%) while in the container the value of the top load of Example 1 is significantly higher (about 18% greater.)

What is claimed is:

1. A container comprising a propylene, ethylene and 1-hexene terpolymer comprising:
(i) an ethylene content of 0.6-1.1 wt %;
(ii) a 1-hexene content of 1.1-2.8 wt %;
(iii) an ethylene 1-hexene ratio (C₂/C₆) that fulfills the following equation (I);
0.20<C₂/C₆<0.39;
where C₂ is the ethylene content wt % and C₆ is the 1-hexene content wt %; and
(iv) the melt flow rate (MFR, ISO 1133, 230° C., 2.16 kg) is 32-64 g/10 min.

2. The container of claim 1, wherein the 1-hexene content is 1.3-2.6 wt %.

3. The container of claim 1, wherein the ethylene content is 0.64-0.9 wt %.

4. The container of claim 1, wherein equation (I) is 0.20<C₂/C₆<0.38.

5. The container of claim 1, wherein the MFR, is 35-54 g/10 min.

6. The container of claim 1 comprising a top load as measured on a container having a 0.4 mm wall thick at 23° C. of greater than 250 N.
